(19) United States
(12) Patent Application Publication
(10) Pub. No.: US 2013/0127165 A1
(43) Pub. Date: May 23, 2013

(54) WIND POWER ELECTRICITY GENERATING SYSTEM AND RELATIVE CONTROL METHOD

(71) Applicant: Harri Vihriälä, Ingolstadt (DE)

(72) Inventor: Harri Vihriälä, Ingolstadt (DE)

(73) Assignee: WILIC S.A.R.L., Luxembourg (LU)

(21) Appl. No.: 13/376,534

(22) PCT Filed: Jun. 10, 2010
(86) PCT No.: PCT/EP2010/058140

§ 371 Date: Mar. 23, 2012

(30) Foreign Application Priority Data
Jun. 10, 2009 (IT) MI2009A 001028

(51) Int. Cl. H02P 9/04

(52) U.S. Cl. CPC H02P 9/04
USPC 290/44

(57) ABSTRACT

A snow groomer, equipped with a winch assembly to aid handling of the snow groomer on steep slopes, has a frame; a user interface; a control unit; and the winch assembly, which has a support structure fixed or connected to the frame, a drum that rotates with respect to the support structure about an axis, a cable fixed or connected at one end to the drum and wound about the drum, an actuator assembly for rotating the drum about the axis, and a sensor for determining the position of the drum about the axis; the control unit being configured to control the cable as a function of the position of the drum and the geometry of the drum.

### PRIORITY CLAIM

This application is a national stage application of PCT/EP2010/058140, filed on Jun. 10, 2010, which claims the benefit of and priority to Italian Patent Application No. M12009A 001028, filed on Jun. 10, 2009, the entire contents of each are incorporated by reference herein.

### BACKGROUND

Certain known wind power electricity generating systems comprise a hub; a number of blades fitted to the hub; and an electric machine comprising a stator and a rotor.

In actual use, the wind blows on the blades of these known wind power electricity generating systems to rotate the hub about the axis, and to transfer the kinetic energy of the wind to the hub; and rotation of the hub is transferred to the electric machine, in particular to the rotor which is connected to and rotates with the hub about the axis.

The hub, blades, and rotor define the rotary assembly.

In these known wind power electricity generating systems, the angular speed of the rotary assembly must be detected to control the wind power system. More specifically, the angular speed of the rotor must be detected to control an inverter coupled to the electric machine, and/or to control the pitch of the blades with respect to the wind, and/or to calculate the power coefficient of the system, and/or to monitor system operation and efficiency, and/or to keep within a maximum angular speed.

The angular speed detection device most commonly employed in known wind power systems is an encoder, of which there are various types. The most commonly used are incremental and absolute encoders, which comprise a photodetector or proximity sensor.

Incremental and absolute encoders comprise a disk, the lateral face of which has at least one succession of holes arranged in at least one circle; and a device for detecting the holes. The disk is fixed to the rotary assembly, and the hole detecting device is fixed to the nacelle.

An incremental encoder disk has at least one succession of equally spaced holes, and the hole detecting device comprises at least one proximity sensor alongside the disk, or at least one light source and at least one photodetector on either side of the disk.

As the disk rotates, the hole detecting device detects the holes and generates a signal indicating the angular distance travelled and the angular speed of the disk, and therefore of the rotary assembly.

Some incremental encoders have at least two proximity sensors or at least two photodetectors, and holes arranged in at least two circles, and detect the rotation direction of the disk.

In known absolute encoders, on the other hand, the holes are arranged unevenly in a given configuration in at least two circles, and the hole detecting device comprises at least two photodetectors or at least two proximity sensors. Absolute encoders process the signals from the proximity sensors or photodetectors to determine angular position with respect to a fixed reference.

One problem of using known encoders in direct-transmission wind power systems lies in the encoder requiring a large disk fixed to the rotary assembly.

In some known direct-transmission wind power systems, the rotor and hub are hollow, are connected directly to each other, and have inside diameters allowing access by workers to the inside for maintenance or inspection. In such cases, using an encoder calls for a disk fixed to the rotary assembly and large enough to permit easy access, which poses two problems: the weight of the disk itself, and the precision with which the holes are formed, which affects the accuracy with which angular speed is determined. Moreover, encoders are sensitive to vibration caused by the blades; and the holes are subject to clogging by dirt, thus impairing reliability of the hole detecting device.

In order to overcome this drawback, U.S. Published Patent Application No. 2009/047130 discloses an accelerometer combined with a gyroscope both mounted of the hub for retrieving the angular speed and the angular position, PCT Patent Application No. WO 2009/001310 discloses three accelerometer mounted of the hub for retrieving the angular position of the rotor assembly, and German Patent No. 10 2007 030268 discloses an accelerometer mounted on the blade for retrieving the dynamic parameters. However, the above disclosed techniques fail to be highly accurate.

### SUMMARY

The present disclosure relates to a wind power electricity generating system and relative control method.

More specifically, one embodiment of the present disclosure relates to a wind power electricity generating system comprising a nacelle; a rotary assembly rotating about an axis with respect to the nacelle; and an angular speed detection device for detecting the angular speed of the rotary assembly.

It is an advantage of the present disclosure to provide a wind power system equipped with an angular speed detection device configured to eliminate certain of the drawbacks of certain of the known art.

According to one embodiment of the present disclosure, there is provided a wind power electricity generating system comprising a nacelle; a rotary assembly rotating about an axis with respect to the nacelle;

an electric machine comprising a stator and a rotor and an angular speed detection device for detecting the angular speed of the rotary assembly; the angular speed detection device comprising at least one sensor rotating about the axis together with the rotary assembly, and supplies at least one signal related to angular speed; wherein the rotary assembly comprises a hub; at least one blade fitted to the hub; and the rotor of the electric machine, connected to the hub; and the wind power electricity generating system characterized in that the sensor is fixed to the rotor of the electric machine.

In one embodiment, the rotary assembly comprises a hub; at least one blade fitted to the hub; and a rotor connected to the hub.

In another embodiment, the sensor is fixed to the rotor.

It is a further advantage of the present disclosure to provide a method of controlling a wind power system, configured to eliminate certain of the drawbacks of certain of the known art.

According to one embodiment of the present disclosure, there is provided a method of controlling a wind power electricity generating system; the wind power system comprising a nacelle, a rotary assembly rotating about an axis with respect to the nacelle, an electric machine comprising a stator and a rotor; the method comprising the step of acquiring a signal, related to the angular speed of the rotary assembly; the method being characterized by acquiring the signal of at least one sensor fixed to the rotor of the electric machine rotating about the axis together with the rotary assembly.

Additional features and advantages are described in, and will be apparent from, the following Detailed Description and the figures.

### BRIEF DESCRIPTION OF THE DRAWINGS

A non-limiting embodiment of the present disclosure will be described by way of example with reference to the accompanying drawings, in which:

FIG. 1 shows a partly sectioned side view, with parts removed for clarity, of a wind power electricity generating system in accordance with one embodiment of the present disclosure;

FIG. 2 shows a larger-scale, partly sectioned side view, with parts removed for clarity, of a detail of FIG. 1;

FIG. 3 shows a partly sectioned, schematic view in perspective, with parts removed for clarity, of a detail of FIG. 1; and

FIG. 4 shows a larger-scale, partly sectioned side view, with parts removed for clarity, of a further embodiment of the present disclosure.

### DETAILED DESCRIPTION

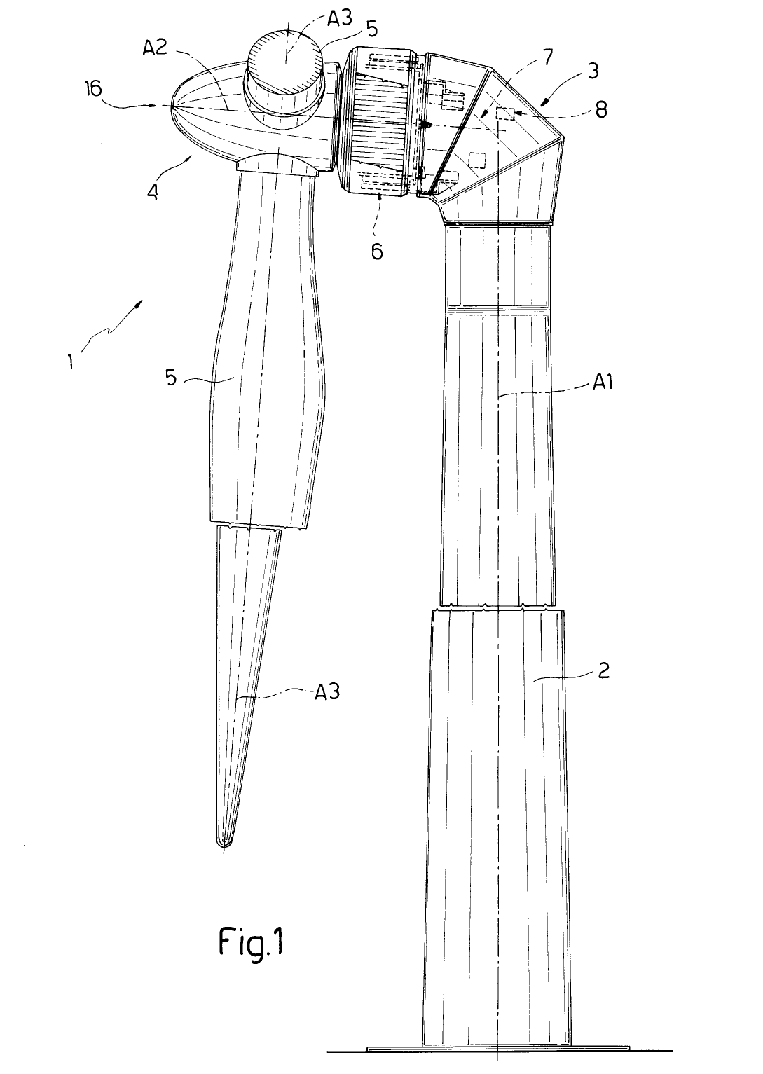

Referring now to the example embodiments of the present disclosure illustrated in FIGS. 1 to 4, number 1 in FIG. 1 indicates a wind power electricity generating system.

In the example shown, system 1 is a variable-angular-speed, direct-transmission wind power system.

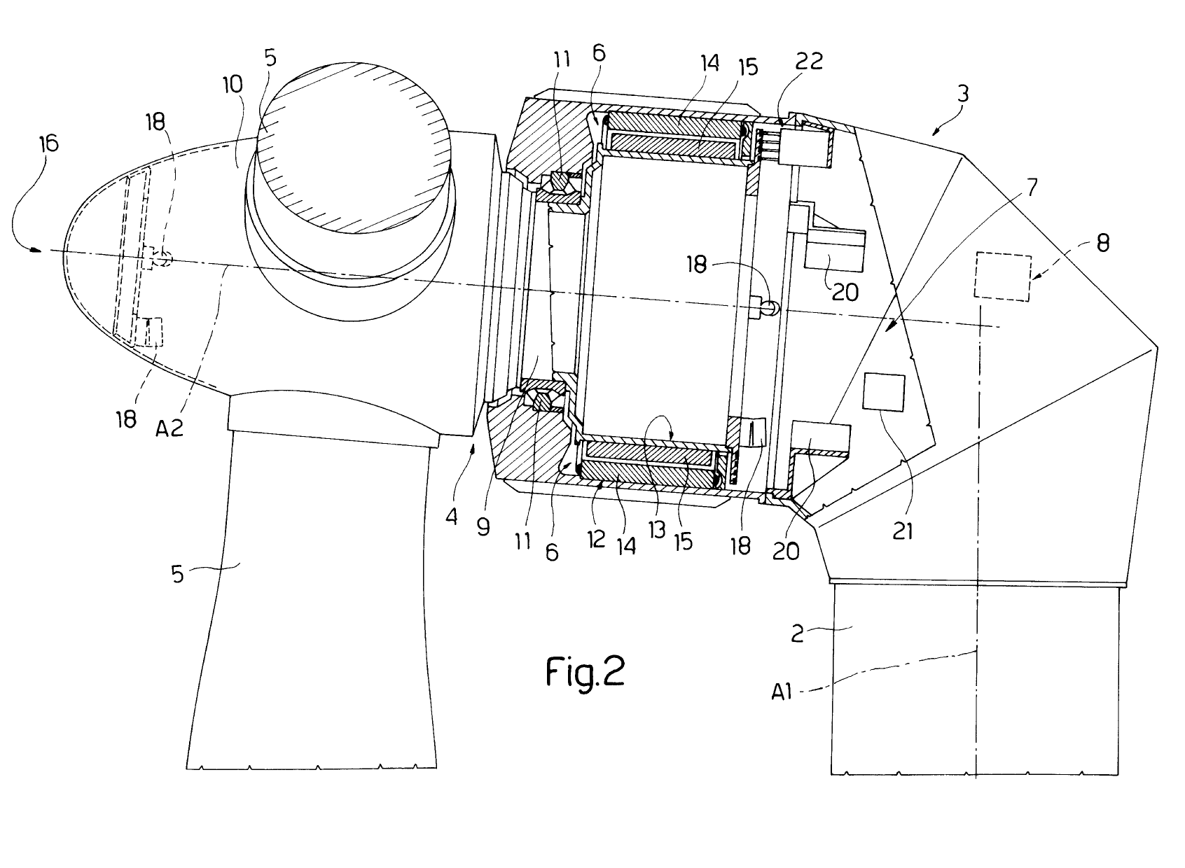

Wind power system 1 comprises a pylori 2, a nacelle 3, a hub 4, three blades 5, an electric machine 6, an angular speed detection device 7 (FIG. 2), and a control device 8 (FIG. 2).

The three blades 5 are fitted to hub 4, which in turn is fitted to nacelle 3, in turn fitted to pylori 2.

Nacelle 3 is mounted to rotate about an axis A1 with respect to pylori 2 to position blades 5 facing the wind; hub 4 is mounted to rotate about an axis A2 with respect to nacelle 3; and each blade 5 is mounted to rotate about a respective axis A3 with respect to hub 4.

In the FIG. 1 example, axis A2 is tilted slightly with respect to the horizontal, and axis A3 is substantially perpendicular to and radial with respect to axis A2.

With reference to FIG. 2, hub 4 comprises a hollow shaft 9 and a body 10, which are connected rigidly to each other and have inside diameters large enough to permit worker access to the inside for maintenance or inspection.

Hollow shaft 9 is fitted, on bearings 11, to nacelle 3 and connected directly to electric machine 6.

Electric machine 6 comprises a stator 12 and a rotor 13. Stator 12 defines a portion of nacelle 3 and comprises stator windings 14; and rotor 13 is hollow, comprises permanent magnets 15, and is fixed directly to hollow shaft 9.

In the example shown, electric machine 6 is synchronous.

The wind rotates hub 4 about axis A2; rotation of hub 4 is transferred to and rotates rotor 13 about axis A2; and the relative movement of permanent magnets 15 with respect to stator windings 14—in the form of rotation of rotor 13 at variable angular speed—induces voltage at the terminals of stator windings 14.

Hub 4, blades 5, and rotor 13 are integral with one another, and define a rotary assembly 16 rotating about axis A2 with respect to nacelle 3.

With reference to FIG. 1, the pitch of each blade 5 with respect to the wind is controlled by rotating blade 5 about respective axis A3 to adjust the surface of incidence with respect to the wind. Rotation of each blade 5 about respective axis A3 is controlled on the basis of efficiency parameters of wind power system 1, and so as to keep rotary assembly 16 within a maximum angular speed.

Angular speed is detected by angular speed detection device 7 (FIG. 2).

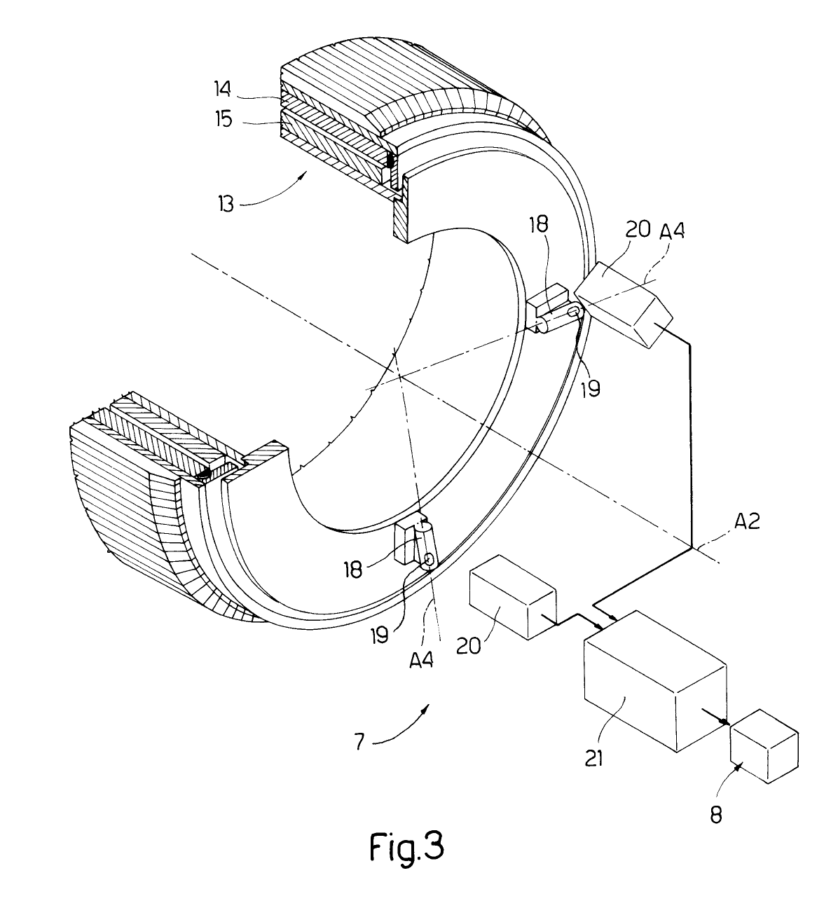

With reference to FIG. 3, angular speed detection device 7 comprises two sensors 18, each comprising a transmitter 19; two receivers 20, each coupled to respective transmitter 19; and a processing unit 21 coupled to receivers 20.

More specifically, each sensor 18 is an accelerometer, and supplies a signal related to angular speed.

Each sensor 18 determines the acceleration caused by gravitational force and/or centrifugal force along a respective detection axis A4 integral with respective sensor 18.

Each sensor 18 is fixed to rotor 13 (as shown by the continuous lines in FIGS. 2 and 3). In FIG. 3, sensors 18 are positioned that respective detection axes A4 are perpendicular to each other and radial with respect to axis A2. Each detection axis A4, however, may be set to any position, except that in which it is parallel to axis A2 or aligned with the other detection axis A4.

In actual use, as rotor 13 rotates about axis A2, the force of gravity measured by each sensor 18 along respective detection axis A4 varies due the change in direction of respective detection axis A4 with respect to the ground, and each sensor 18 also detects along respective detection axis A4 acceleration caused by the centrifugal force produced by rotation of rotor 13.

When rotor 13 rotates at angular speed, therefore, each sensor 18 emits a signal that, allowing for tolerances and variations in angular speed, is practically sinusoidal; and, given that respective detection axes A4 of sensors 18 are perpendicular, the respective signals are phase shifted 90 degrees.

With reference to FIG. 2, receivers 20 and processing unit 21 are housed inside nacelle 3, close to sensors 18, and integral with nacelle 3.

Each signal is received by respective receiver 20 which transmits it to processing unit 21.

Alternatively, instead of transmitters 19 and receivers 20, angular speed detection device 7 comprises contact members 22 which provide sliding contacts; each sensor 18 is coupled by contact members 22 to processing unit 21; and the signal from each sensor 18 is supplied to processing unit 21 via contact members 22.

Processing unit 21 processes one or both of the signals from sensors 18 to determine the angular speed of rotary assembly 16.

Processing unit 21 also processes one or both of the signals from sensors 18 to determine the angular position of rotary assembly 16.

With reference to FIG. 2, angular speed detection device 7 is coupled to control device 8.

Control device 8 controls wind power system 1 on the basis of the angular speed and/or angular position of rotary assembly 16 supplied by angular speed detection device 7. The control functions performed by control device 8 include: monitoring correct operation of wind power system 1; controlling the pitch of blades 5 with respect to the wind; controlling the power coefficient of wind power system 1; controlling the inverter coupled to electric machine 6; controlling the efficiency of wind power system 1; and keeping rotary assembly 16 within the maximum angular speed.

Control device 8 also processes the angular speed and/or angular position of rotary assembly 16 by fast Fourier transform (FFT) to determine events.

In one embodiment, additional communication means (not shown in the drawings) are associated with control device 8 of wind power system 1 to transmit the angular speed and/or angular position of rotary assembly 16 to a remote control centre (not shown in the drawings) coupled by cable or radio to wind power system 1.

In one variation of the present disclosure, as opposed to being fixed to rotor 13, each sensor 18 is fixed to hub 4, and more specifically to an inner wall of body 10 (as shown by the dash lines on the left of FIG. 2).

In another variation of the present disclosure (not shown in the drawings), as opposed to being fixed to rotor 13, each sensor 18 is fixed to any one of the three blades 5, and more specifically to an inner wall of blade 5.

In another variation of the present disclosure, each sensor 18 is an inclinometer that supplies a signal related to angular speed; and processing unit 21 calculates angular speed by processing the signal from each inclinometer.

In another variation of the present disclosure, angular speed detection device 7 comprises only one sensor 18 fixed to rotor 13 or hub 4; sensor 18 supplies a signal related to angular speed; and processing unit 21 calculates angular speed on the basis of the signal from sensor 18.

In another variation of the present disclosure, angular speed detection device 7 comprises only one sensor 18 in the form of a two-axis accelerometer or a two-axis inclinometer.

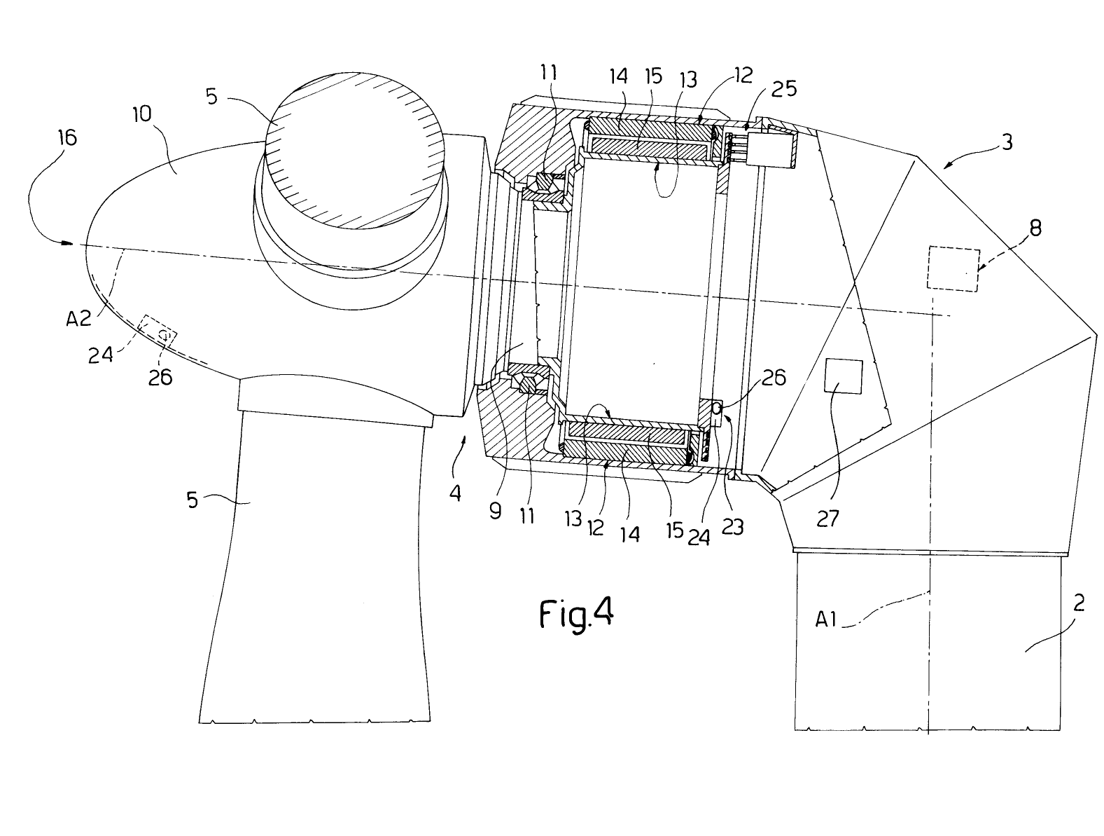

In a further embodiment of the present disclosure shown in FIG. 4, in which parts similar to those of the first embodiment are indicated using the same reference numbers as in FIGS. 1 to 3, angular speed detection device 7 is replaced with an angular speed detection device 23.

Angular speed detection device 23 comprises a sensor 24 defined by a gyroscope based on detection of Coriolis forces; and contact members 25.

Sensor 24 is fixed to rotary assembly 16, and more specifically to rotor 13 (as shown by the continuous line in FIG. 4); or is fixed to hub 4, and more specifically to an inner wall of body 10 (as shown by the dash line on the left in FIG. 4).

Angular speed detection device 23 is coupled to control device 8 of wind power system 1 by contact members 25 to supply control device 8 with the angular speed of rotary assembly 16.

Sensor 24 is a gyroscope and supplies a signal related to angular speed. More specifically, the signal is a voltage proportional to the angular speed of rotary assembly 16.

Sensor 24 is coupled to control device 8 by contact members 25, which provide sliding contacts by which the signal from sensor 24 is supplied to control device 8. Alternatively, instead of contact members 25, the sensor comprises a transmitter 26; angular speed detection device 23 comprises a receiver 27 coupled to control device 8 and for receiving signals from transmitter 26; and sensor 24 transmits signals to control device 8 by means of transmitter 26 and receiver 27.

In a variation of the present disclosure, sensor 24 is fixed to the inside of body 10 (as shown by the dash line in FIG. 4).

In another variation of the present disclosure (not shown in the drawings), sensor 24 is fixed to any one of the three blades 5, and more specifically to an inner wall of blade 5.

Though specific reference is made herein to a synchronous electric machine, the electric machine may be of any other known type, e.g. asynchronous.

Clearly, changes may be made to the system and method as described herein without, however, departing from the scope of the accompanying claims. That is, it should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-20. (canceled)

21. A wind power electricity generating system comprising:
a nacelle;
a rotary assembly rotating about an axis with respect to the nacelle; and
an electric machine including:
a stator,
a rotor, and
an angular speed detection device configured to detect the angular speed of the rotary assembly, the angular speed detection device including:
at least one sensor configured to rotate about the axis together with the rotary assembly, and configured to supply at least one signal related to angular speed,
wherein the rotary assembly includes:
a hub,
at least one blade fitted to the hub, and
the rotor of the electric machine is connected to the hub; and
wherein the sensor is fixed to the rotor of the electric machine.

22. The wind power electricity generating system of claim 21, including a control device coupled to the angular speed detection device, the control device being configured to control the wind power system based on the angular speed supplied by the angular speed detection device.

23. The wind power electricity generating system of claim 21, including an inverter coupled to the electric machine, the angular speed detection device being coupled to the inverter.

24. The wind power electricity generating system of claim 21, wherein the sensor is an accelerometer or an inclinometer.

25. The wind power electricity generating system of claim 24, wherein the angular speed detection device includes a processing unit configured to process the signal related to angular speed.

26. The wind power electricity generating system of claim 25, wherein:
the sensor includes a transmitter, preferably a wireless transmitter;
the angular speed detection device includes a receiver coupled to the processing unit and preferably fixed with respect to stator; and
the sensor is coupled to the receiver by the transmitter and configured to supply the processing unit with the signal related to angular speed.

27. The wind power electricity generating system of claim 25, wherein the angular speed detection device includes a plurality of contact members configured to couple the sensor to the processing unit.

28. The wind power electricity generating system of claim 25, wherein the processing unit is configured to process the signal related to angular speed to determine the angular position of the rotary assembly.

29. The wind power electricity generating system of claim 24, wherein the sensor has a detection axis not parallel to the axis of the rotary assembly.

30. The wind power electricity generating system of claim 24, wherein:
the angular speed detection device includes at least one further sensor configured to rotate about the axis together with the rotary assembly and configured to supply at least one further signal related to angular speed; and
the sensor and the further sensor have respective detection axes not aligned with each other; the further sensor preferably being an accelerometer or an inclinometer.

31. The wind power electricity generating system of claim 24, wherein the sensor is a two-axis sensor.

32. The wind power electricity generating system of claim 21, wherein the sensor is defined by a gyroscope.

33. The wind power electricity generating system of claim 32, wherein the sensor is coupled to the control device by contact members.

34. The wind power electricity generating system of claim 32, wherein:
the sensor includes a transmitter, and
the angular speed detection device includes a receiver coupled to the transmitter and to the control device;
the sensor being coupled to the control device by the transmitter and the receiver.

35. The wind power electricity generating system of claim 21, including a control device configured to process the signal related to angular speed by fast Fourier transform to determine events, preferably to monitor correct operation of the wind power system.

36. A method of controlling a wind power electricity generating system, the wind power electricity generating system including a nacelle, a rotary assembly configured to rotate about an axis with respect to the nacelle, and an electric machine including a stator and a rotor, the method comprising:
acquiring a signal, related to the angular speed of the rotary assembly, by acquiring the signal of at least one sensor fixed to the rotor of the electric machine rotating about the axis together with the rotary assembly.

37. The method of claim 36, wherein the wind power electricity generating system includes a control device connected to the sensor and the method includes causing the control device to control the wind power system based on the angular speed determined by the sensor.

38. The method of claim 36, which includes causing a processing unit to process the signal related to angular speed by determining the angular speed of the rotary assembly.

39. The method of claim 38, which includes causing a processing unit to process the signal related to angular speed by determining the angular position of the rotary assembly.

40. The method of claim 36, wherein the sensor has a detection axis and which includes positioning the sensor so that the detection axis is not parallel to the axis of the rotary assembly.
